(19) United States
(12) Patent Application Publication
(10) Pub. No.: US 2010/0027248 A1
(43) Pub. Date: Feb. 4, 2010

(54) Solar Lamp

(76) Inventor: Kao-Hsung Tsung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/219,791

(22) Filed: Jul. 29, 2008

(51) Int. Cl. F21L 4/00

(52) U.S. Cl. 362/183

(57) ABSTRACT

The present invention discloses a solar lamp includes a solar panel installed onto a housing, a battery, an optical switch, an illuminating light, and an integrated circuit board contained in the housing. The solar panel, the battery and the integrated circuit board are connected to constitute a charge circuit, and the battery, the optical switch, the illuminating light and the integrated circuit board are connected to constitute an illumination circuit, and the charge circuit converts solar energy into electric energy for lighting up the illuminating light of the illumination circuit. The solar lamp of the invention is convenient to carry and use.

### BACKGROUND OF THE INVENTION

1. Field of the Invention

The present invention relates to a lamp, and more particularly to a lamp using solar energy for its illumination.

2. Description of the Related Art

In the era of energy crisis and fuel shortage, solar energy is generally used as a power source of lamps, which is a good way of saving energy. At present, existing solar lamps come with complicated structure and components, and thus these solar lamps are suitable to be used as road lamps. As to a standalone night lamp, indicating lamp or mini lamp, there is no related design, particularly for portable lamps such as warming lamps, bicycle tail lamps, working lamps, and portable flashlights. Most of these portable lamps rely on battery for their electric power source. Although the use of battery is convenient, it also causes an issue of environmental pollution.

In view of the foregoing shortcomings of the prior art, the inventor of the present invention developed a solar lamp in accordance with the present invention to overcome the shortcomings of the prior art.

### SUMMARY OF THE INVENTION

It is a primary objective of the invention to provide a solar lamp that can be used as a night lamp, an indicating lamp, a mini lamp or a portable lamp to save energy and overcome the issue of environmental pollution.

Another objective of the present invention is to provide a solar lamp that can be installed freely at a place according to the actual needs.

To achieve the foregoing objectives, the present invention adopts the following technical solutions. The solar lamp comprises a housing, a solar panel installed on the housing, a battery, an optical switch, an illuminating light and an integrated circuit board contained in the housing, wherein the solar panel, the battery and the integrated circuit board are connected to constitute a charge circuit, and the battery, the optical switch, the illuminating light and the integrated circuit board are connected to constitute an illumination circuit, and the charge circuit converts solar energy into electric energy for lighting up the illuminating light of the illumination circuit.

A housing of the solar lamp in accordance with the present invention comes with a design that facilities the carrying and use of the solar lamp, and the size of the housing can be designed according to actual requirements. The larger the housing, the larger is the illuminating area. Therefore, a large housing can be used for a general illuminating light, and a small housing can be used for an indicating lamp, a night lamp, a decoration lamp, or a mini lamp. In a small housing, an LED lamp is used as the illuminating light, which has the advantages of long life and low power consumption.

In practical applications, the housing can be designed as a rectangular, circular, or spherical transparent housing. Of course, the shape of the housing can be designed in a 3D artistic style according to actual need or personal preference. The transparent housing allows light to pass through the housing into the optical switch inside the housing and facilitate installing the optical switch in the housing, and the manual switch is provided for switching on/off the illumination circuit of the solar lamp. If the illuminating light is installed inside the housing, the illuminating light can be passed through easily.

The solar panel can be fixed on a surface of the housing, or a surface of the housing is made of a solar panel directly to save materials. A fixing means can be installed at the bottom of the housing, and the fixing means can be an adhesive tape, a double-sided adhesive tape or a magnet for adhering or attaching the whole set of the solar lamp to an appropriate position.

Compared with the prior art, the solar lamp of the present invention installs all components and circuits in the housing or on the wall of the housing, so that the solar lamp can be used as a night lamp, an indicating lamp, a small flashlight, a water-surface indicating buoy, a decoration lamp or a mini lamp, and carried and used conveniently. The design of the fixing means at the bottom of the housing makes it convenient to install and fix the solar lamp. After finishing a use of the solar lamp, the lamp can be removed easily.

### BRIEF DESCRIPTION OF THE DRAWINGS

FIG. 1 is a schematic perspective view of an assembly in accordance with the present invention;

FIG. 2 is an exploded view of a preferred embodiment of the present invention; and

FIG. 3 is a schematic view of installing a solar lamp to a barbeque stove in accordance with a preferred embodiment of the present invention.

### DETAILED DESCRIPTION OF THE PREFERRED EMBODIMENT

The present invention is illustrated in details by a preferred embodiment together with its related drawings as follows.

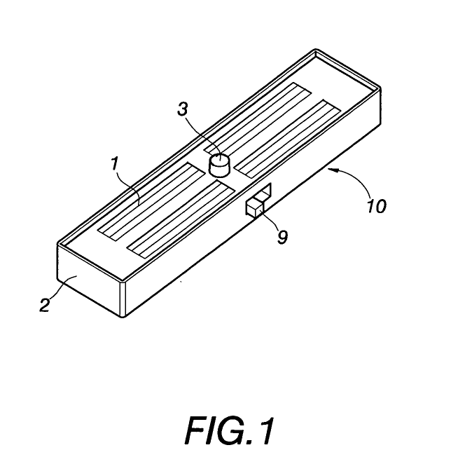

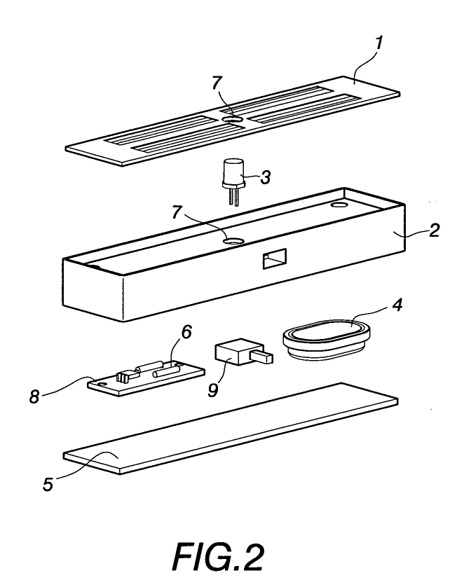

In FIGS. 1 and 2, a solar lamp 10 of the present invention comprises a housing, a solar panel 1, an illuminating light 3, a battery 4, an optical switch 6, and an integrated circuit board 8. The housing is composed of a chassis 5 and an upper casing 2. In this embodiment, the housing is in a rectangular shape, but the housing can be designed in a cylindrical shape, an arc shape or any other artistic stylish shape according to actual need and personal preference.

The upper casing 2 is made of a transparent material, so that light can pass through the upper casing 2 to the optical switch 6 in the housing. The solar panel 1 is fixed to an upper surface of the upper casing 2, and the solar panel 1 is exposed to the outside for receiving light. The illuminating light 3 of this embodiment is an LED lamp, and the top of the illuminating light 3 is passed through a lamp hole 7 disposed on the upper surface of the upper casing 2 and on the solar panel 1, and the illuminating light 3 is exposed to the outside to facilitate the illumination.

For a mild light such as the light used for a night lamp, the illuminating light 3 can be installed inside the transparent housing. The battery 4 and the integrated circuit board 8 are installed and fixed inside the housing. In this embodiment, a manual switch 9 is provided to facilitate users to interrupt a circuit during transportation or not using the solar lamp for a long time, so as to prevent the solar lamp from emit light automatically in a dark environment.

The integrated circuit 8 includes a charge circuit and an illumination circuit, wherein the solar panel 1, the battery 4 and the integrated circuit 8 are connected to constitute a charge circuit, and the battery 4, the optical switch 6, the illuminating light 3 and the integrated circuit 8 are connected to constitute an illumination circuit. The connection of circuit of the invention is a prior art, and thus will not be described here.

In an embodiment, a double-sided adhesive tape (not shown in the figure) is attached on an external surface of the chassis 5 for fixing the whole set of the solar lamp 10. A magnet is installed on the chassis 5 and at a position corresponding to the fixing position of the solar lamp, if the solar lamp is fixed on a metal surface, so that the attraction force of the magnet installed on the chassis 5 can be used for fixing the solar lamp and facilitating the installation or removal of the solar lamp. Of course, the solar lamp can be fixed by another fixing means such as a screw.

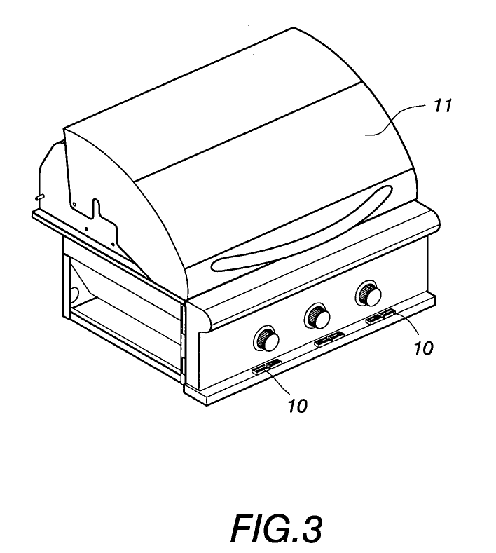

In FIGS. 2 and 3, the solar lamp 10 is applied to an outdoor barbeque stove 11, and the solar lamp 10 is attached onto a handle of an oil collecting tray or a control panel of the barbeque stove 11. When there is sunlight, the solar energy absorbed by the solar panel 1 is passed through the charge circuit and converted into electric energy, and then the electric energy is stored in the battery 4. If the visibility of the outdoor light becomes weaker, the optical switch 6 will automatically start the illumination circuit to light up the illuminating light and illuminate the control panel of the barbeque stove to facilitate the operation of the barbeque stove.

Since the solar lamp comes with a light, thin, short and compact design and features a low price, a long life, and a safe use without requiring additional circuits, the solar lamp can be used extensively in different areas including a warning lamp, a bicycle tail lamp, a working lamp, an indicating lamp, a decoration lamp, a night lamp, a portable flash and the like even in a dark environment. In general, the solar power of the solar lamp can last for 4 to 5 hours of illumination.

While the invention has been described by means of specific embodiments, numerous modifications and variations of structure, means and characteristic could be made thereto by those skilled in the art without departing from the scope and spirit of the invention set forth in the claims.

What is claimed is:

1. A solar lamp, comprising a solar panel, a battery, an optical switch, an illuminating light, and an integrated circuit board, wherein the solar panel, the battery and the integrated circuit board are coupled to constitute a charge circuit, and the battery, the optical switch, the illuminating light and the integrated circuit board are coupled to constitute an illumination circuit, and the solar panel is installed on an external surface of a housing, and the housing contains the battery and the integrated circuit board, and the illuminating light and the optical switch are installed on a wall of the housing or inside the housing.

2. The solar lamp of claim 1, wherein the housing is a rectangular or circular transparent housing.

3. The solar lamp of claim 2, wherein the solar panel is fixed on a surface of the housing, and the bottom of the housing includes a fixing means.

4. The solar lamp of claim 3, wherein the fixing means is an adhesive tape or a magnet.

5. The solar lamp of claim 1, wherein the illuminating light is an LED lamp.
